(19) United States
(12) Patent Application Publication
(10) Pub. No.: US 2025/0364197 A1
(43) Pub. Date: Nov. 27, 2025

(54) Furnace Diagnostic By-Pass Apparatus

(71) Applicant: Jeremy Stone, Louisville, KY (US)

(72) Inventor: Jeremy Stone, Louisville, KY (US)

(21) Appl. No.: 18/670,259

(22) Filed: May 21, 2024

(51) Int. Cl. H01H 35/26; H01H 23/02

(52) U.S. Cl. CPC H01H 35/2607; H01H 23/025

(57) ABSTRACT

A diagnostic by-pass apparatus electrically connectable to a pressure switch, a roll-out switch, and a limit switch of a furnace is disclosed. Each switch has two electrical leads. The apparatus includes a housing, an enclosure in the housing, an electrical circuit in the enclosure, and a continuity indicator electrically connected to the circuit and electrically connectable to both leads of each switch, one at a time. The indicator is used to identify a defective switch when the by-pass apparatus is connected to both leads of the switch.

### FIELD

The present subject matter is directed to a furnace diagnostic by-pass apparatus.

### BACKGROUND

Current attempts to integrate furnace control often fail to adequately check for false information and generally fail to combine testing of safety sensors for false indications both when a sensor should be detecting a particular burner parameter and when the sensor should not be sensing that parameter; and such attempts therefore lack versatility.

For instance, U.S. Pat. No. 4,842,510 to Grunden et al. is directed to an integrated electronic control arrangement in an illustrative environment of a burner such as a modern gas-fired furnace. A controller incorporates a self-test feature that shuts down the furnace in the event of any one of several possible sensed faults. Self-testing occurs automatically before an attempt at ignition and during furnace operation. Pre-programmed functioning of a sensor, designed sense induced air flow through the burner combustion chamber, is tested prior to enabling a fan sized to cause such induced air to flow. Air flow is confirmed by sending to, and receiving back from, the sensor a sequence of pulses. Should air flow not be sensed during a combustion period, combustion is terminated. A flame sensor is provided for determining the presence of a flame in the combustion chamber; and during times when a flame should be present, pulse sequences are sent to, and received back from, the flame sensor to confirm that a flame is present. When it is known that no flame is present, if pulses sent earlier are received back, a “fault” occurs, and the system locks out; and if—at any time—pulses are received when none were sent the system locks out.

U.S. Pat. No. 4,872,828 to Mierzwinski et al. discloses another integrated electronic control arrangement in an illustrative environment of a gas-fired furnace. A controller of the '828 patent incorporates a self-test feature that shuts down a furnace and displays a diagnostic fault code whenever any one of several possible “faults” is sensed. Self-testing occurs automatically before an attempt at ignition and during furnace operation. Such a self-test may also be initiated manually when a furnace is not operating. The controller accepts digital information on daily temperature setback, weekend temperature setback, and vacation temperature setback, in any one of several preset schedules, and preset setback increments. The controller has a multipurpose display to selectively show select indicative failure codes, temperature setback schedules, time of day, and day of the week.

The complexity of modern heating systems has often complicated the diagnoses and repair of faults from which such systems may suffer. Misdiagnoses and replacement of wrong components, both expensive and time consuming, often pose a substantial nuisance to all parties involved. In situations where a homeowner experiences repetitive malfunctioning of a heating system and schedules several service calls and associated appointments, service providers must allocate time and labor to dispatch personnel into the field to address each problem while select furnace manufacturers may also be called on to supply replacements for components that are in fact fault free and fully operational.

Solutions to this problem are suggested, for example, in U.S. Pat. Nos. 6,535,838 and 6,658,372—both to Abraham et al.—each of which is directed to a furnace diagnostic system including sensors that monitor various functions of the furnace. Data generated by such sensors may be stored for subsequent transfer or may be transferred in real time via an infrared link to a remote handheld device with which an analysis of the data is performed. The handheld device also allows a technician to control furnace functions to facilitate the generation of relevant real time data. To further enhance system diagnostic capabilities, such communication may also be established with a centralized computing facility including a database that contains data relating to a population of similar furnaces.

Faulty pressure switches have been one of the most misdiagnosed problems in today's modem furnaces. Many pressure switches have been replaced needlessly, simply because there was no proper way to test them. It is typically the technician's best guess as to whether a problem exists which necessitates replacement of the pressure switch. Thus, many service calls could have been resolved easily if the pressure switch was first able to be tested properly before being replaced. While one can test to see if there is enough pressure to close the switch simply by attaching a pressure measuring device, such as a manometer in the line, but this will not tell you if the switch is working properly.

A solution to this problem is suggested in U.S. Pat. No. 7,441,439 to McFarland et al., which is directed to an apparatus for calibrating and testing pressure switches typically used in residential and/or commercial heating, ventilation, and air conditioning (“HVAC”) systems. The apparatus is used to test, set, or adjust a pressure switch to manufacturer specifications. The apparatus includes an exterior housing with an on/off switch, two vacuum nozzles, and a bypass control valve. Within the housing is an air compressor that is in compressed fluid communication with the nozzles and bypass control valve. The air compressor typically operates via battery power supply located in the housing. A pressure measuring device, such as a differential pressure gauge as well as a conductivity indicator are typically used in conjunction with the device to calibrate adjustable pressure switches and to test and diagnose faulty pressure switches. The apparatus can be constructed as a compact, hand-held instrument for use in a typical HVAC service environment and can include the pressure measuring device and/or the conductivity indicator within its housing.

U.S. Pat. No. 10,088,157 to Sutton et al. discloses a multi-sensor probe for monitoring combustion in a conduit. US published patent application 2017/0074589 to Somary et al. discloses a system and a method for facilitating the maintenance of an industrial furnace.

Since the prior art does not disclose a low-cost and effective solution to a problem my technicians experience in a typical service call, my invention is summarized as follows.

### SUMMARY

In a gas-fired furnace there are three main safety components. One component includes a limit switch; another component includes two or more roll-out sensors; a third component includes a pressure switch. The purpose of the limit switch is to protect the furnace from overheating. The roll-out sensors comprise switches that trip if the flames begin to roll out of a burner component or if sensors sense a predetermined temperature.

There are many types of pressure switches in a gas furnace that operate between positive and negative pressures, and pressure switches are known to occasionally fail. For instance, failure may be caused by a clogged vent, a clogged drain, or a cracked heat exchanger caused by normal wear and tear with usage over time. When troubleshooting such failures, leads from a pressure switch are removed and connected to the Diagnostic By-Pass Tool, to allow a technician to bypass the failed component and run the furnace long enough to learn if it or other furnace components—such as a limit switch or a roll-out switch—are in any way a cause of a failure. The limit switch and roll-out switch are each separately and similarly tested to identify root causes of furnace operational failures.

Yet another feature of the Furnace Diagnostic By-Pass Apparatus or Tool of the present subject matter is its light-emitting diode (“LED”) indicator. One purpose of the LED indictor is to ensure that the circuit to each of the three safety components (noted above) is maintaining a 24-volt connection, which is visually confirmed by the LED indicator when it lights up on the Diagnostic By-Pass Tool after each of the safety components is tested.

### BRIEF DESCRIPTION OF THE DRAWING FIGURES

FIG. 1 is a schematic of a wiring diagram for a prior art non-condensing furnace.

FIGS. 2A, 2B, and 2C depict views of hardware components of a prior art furnace.

FIG. 3 depicts a perspective view of the exterior of an embodiment of a furnace diagnostic by-pass apparatus in accordance with principles of the present subject matter.

FIG. 4 presents an isometric view of the present subject matter on a reduced scale relative to FIG. 3, depicting the physical dimensions of a currently illustrative embodiment.

FIG. 5 is an enlarged internal view from the plane 5-5 from a backside of FIG. 4.

FIG. 6 depicts a side elevational view of a component that is also shown in FIG. 5.

FIG. 7 is an electrical schematic in which a switch, when it is closed, causes the electrical circuit to be subjected to a 24-volt AC load and an LED device to be illuminated.

Throughout the drawing figures and the detailed description which follow, similar reference numerals are used to refer to similar components of the present subject matter.

### DETAILED DESCRIPTION

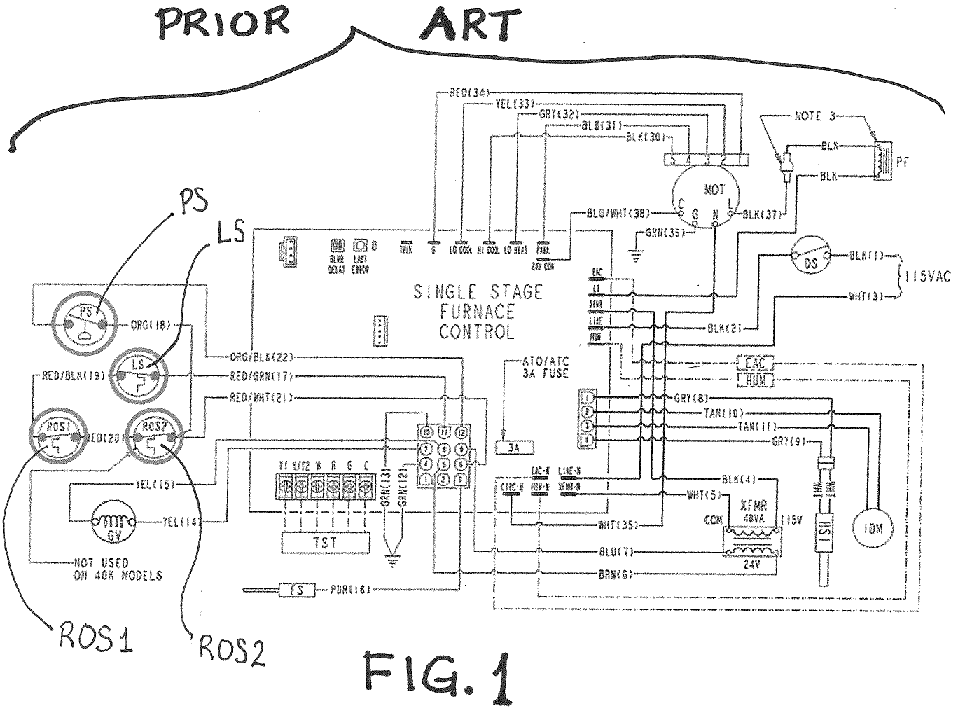

FIG. 1 presents a schematic of a wiring diagram for a York Y81E non-condensing furnace. In the schematic of FIG. 1, the wiring connections for a pressure switch PS, the wiring connections for a limit switch LS, the wiring connections for a first roll-out switch ROS1, and the wiring connections for a second roll-out switch ROS2—are all presented.

Furnace roll-out switches and furnace limit switches, designed for efficient furnace operation are described in detail in U.S. Pat. No. 5,902,099 to Rowlette et al., hereby incorporated by reference in its entirety. In addition, pressure switches, designed for efficient furnace operation, are described in U.S. Pat. No. 8,146,584 to Thompson and U.S. Pat. No. 8,672,670 to Hugghins, both of which are now incorporated by reference in their entirety.

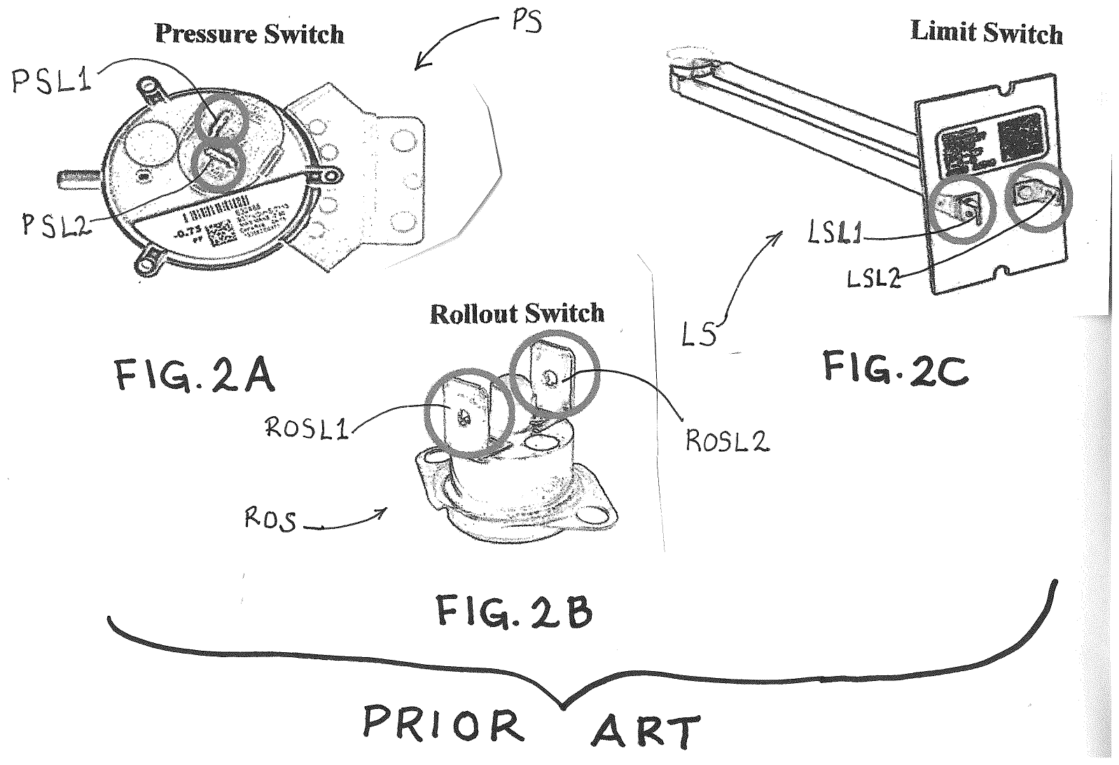

In the wiring diagram of the York Y81E non-condensing gas-fired furnace there are three main safety components. A limit switch LS (FIGS. 1, 2C) is one safety component.

Another safety component includes a pair of roll-out sensors. (See FIG. 1.) One of the sensors is operatively associated with a first roll-out switch ROS1 and the other sensor is operatively associated with a second roll-out switch ROS2. (Please see FIG. 1.) A third safety component includes a pressure switch PS. (FIGS. 1, 2A.) The purpose of a limit switch LS is to protect a furnace from overheating. The roll-out switches ROS1 and ROS2 trip if flames roll out of a burner or if predetermined elevated temperatures are sensed.

Commercially available pressure switches operable in a gas furnace may range between positive and negative gas pressure. As a result, a typical pressure switch May fail in a furnace for many reasons. For example, failure may be caused by a clogged vent or drain or a cracked heat exchanger. Or failure may result from normal wear and tear.

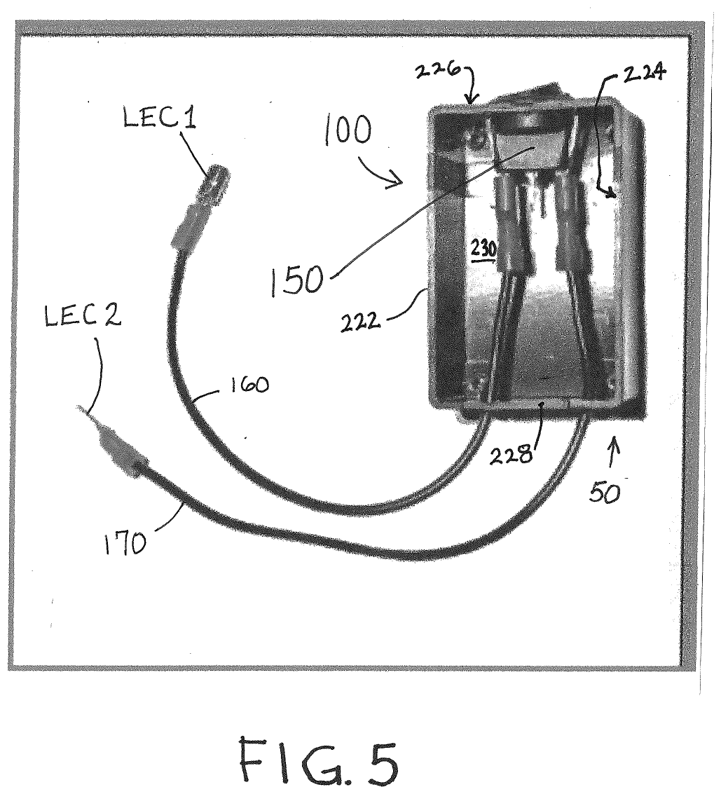

FIGS. 2A, 2B, and 2C depict isometric views of the furnace switches described above. A common pressure switch PS is shown in FIG. 2A. A common roll-out switch ROS is shown in FIG. 2B. A common limit switch LS is shown in FIG. 2C. When troubleshooting a “failure,” a first pressure switch lead PSL1 and a second pressure switch lead PSL2 from pressure switch PS (FIG. 2A) are exposed by removing furnace circuit connections from each. Then, a first lead electrical connection LEC1 of the Diagnostic By-Pass Apparatus or Tool 50 of the present subject matter (FIG. 4) is operatively connected to the first pressure switch lead PSL1 and a second lead electrical connection LEC2 of the Diagnostic By-Pass Tool 50 is operatively connected to the second pressure switch lead PSL2 (FIG. 2A) to investigate if the pressure switch PS of the furnace is defective. Next, a first roll-out switch lead ROSL1 and a second roll-out switch lead ROSL2 from one of the two roll-out switches ROS1 (FIG. 1) are exposed by removing the furnace circuit connections from each of them. Then, the first lead electrical connection LEC1 of the Diagnostic By-Pass Tool 50 is operatively connected to the first roll-out switch lead ROSL1 and the second lead electrical connection LEC2 is operatively connected to the second roll-out switch lead ROSL2 (FIG. 2B) to investigate if the first roll-out switch ROS1 is defective. This procedure is repeated for the other one of the two roll-out switches ROS2. (Please see FIG. 1.) Finally, a first limit switch lead LSL1 and a second limit switch lead LSL2 of the limit switch LS (FIG. 2C) are exposed by removing the furnace circuit connections from each. The first lead electrical connection LEC1 is operatively connected 11 to first limit switch lead LSL1 and the second lead electrical connection LEC2 (FIGS. 4, 5) is operatively connected to second limit switch lead LSL2 (FIG. 2C) to investigate if the limit switch LS (FIGS. 1 and 2C) is defective. Such use of the By-Pass Tool 50 allows a heating, ventilation, and air conditioning (“HVAC”) technician to by-pass a “failed” furnace component and operate a furnace long enough to determine the root cause of its failure.

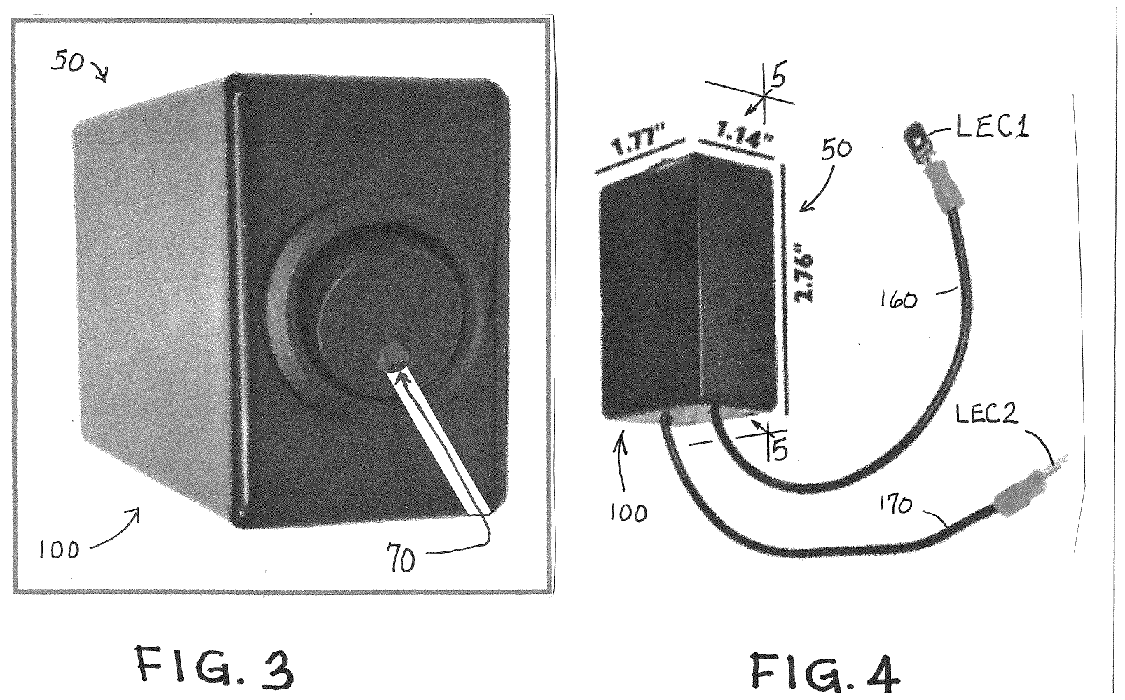

Another feature of the Furnace Diagnostic By-Pass Apparatus (or Tool) 50 of the present subject matter (FIG. 4) involves its visible light-emitting diode (“LED”) indicator 70 (FIG. 3). One purpose of the LED indicator 70 is to ensure that the circuit to each of the three safety components is maintaining a 24-volt connection, which is visually confirmed by the LED indicator 70 when it lights up on the Furnace Diagnostic By-Pass Tool after the By-Pass Apparatus or Tool 50 is operably connected, as described above.

While the Diagnostic By-Pass Apparatus or Tool 50 of the present subject matter can be designed to have any desired size and shape, a current embodiment (FIGS. 3-5) of the present subject matter is of generally rectangular shape and has a height of 70.1 mm (2.76 inches), a width of 45.0 mm (1.77 inches), and a depth of 29.0 mm (1.14 inches).

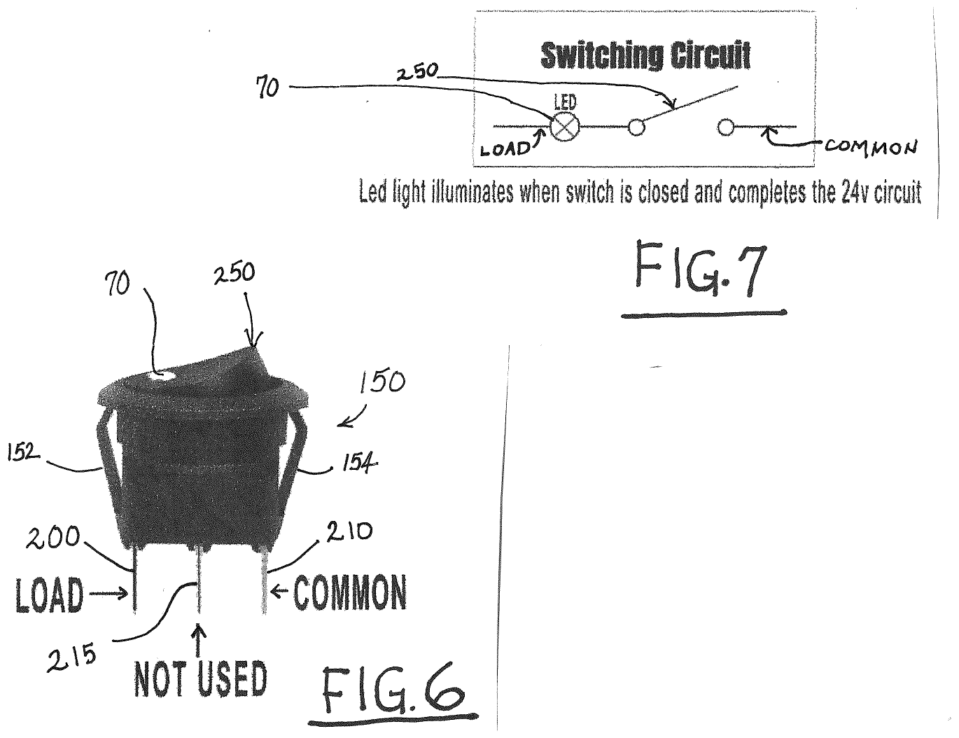

The present subject matter is directed to a diagnostic by-pass apparatus or tool 50 (FIGS. 3-5) electrically connectable to a furnace pressure switch PS (FIG. 2A), a furnace roll-out switch ROS (FIG. 2B), and a furnace limit switch LS (FIG. 2C). Each such switch includes two terminals. The apparatus or tool 50 comprises: a housing 100 (FIG. 3), an enclosure 150 (FIGS. 5, 6) disposed in the housing 100, and an electrical circuit (FIG. 7) contained within the enclosure 150. The apparatus or tool 50 includes a first lead electrical connection operably connected to the electrical circuit and operably connectable to one of the two terminals of the pressure switch, the roll-out switch, and the limit switch. The apparatus or tool 50 also includes a second lead electrical connector operably connected 6 to the electrical circuit and operably connectable to other one of the two terminals of the pressure switch, the roll-out switch, and the limit switch. During operation, a defective 8 pressure switch, a defective roll-out switch, or a defective limit switch may be a root cause 9 of a furnace operational failure. The apparatus or tool also includes an electrical continuity indicator 70 operatively connected to the electrical circuit. The continuity indicator 70 is designed, adapted, and configured to positively identify a defective pressure switch of the furnace, and/or a defective roll-out switch of the furnace, and/or a defective limit switch of the furnace. In embodiments, the electrical continuity indicator 70 can be an LED indicator 70. In embodiments, a first insulated flexible electrical wire or cord 160 (FIGS. 4, 5) connects the first lead electrical connection LEC1 to the electrical circuit in the enclosure 150 within the diagnostic by-pass tool 50 and a second insulated flexible electrical wire or cord 170 connects the second lead electrical connection LEC2 to the electrical circuit.

The enclosure 150 includes a first electrically conductive post 200 (FIG. 6) adapted and configured to receive the 24-volt load. A person of ordinary skill in the art (“POSITA”) knows when to use alternating current (“AC”) or direct current (“DC”) and when it may be necessary to step up or down a DC voltage value. The first electrically conductive post 200 is electrically operatively connected to the first insulated flexible electrical wire or cord 160 (FIGS. 4, 5). The enclosure 150 may include a second electrically conductive post operatively connected to the second insulated flexible electrical wire or cord 170. The enclosure 150 may further include a third electrically post 215 which is not presently used.

The housing 100 includes a first spaced-apart (preferably parallel) pair of sidewalls 222, 224 (FIG. 5) and a second spaced-apart (also preferably parallel) pair of sidewalls 226, 228 disposed transverse (e.g., about 90°) in relation to the first spaced-apart pair of sidewalls 222, 224. Housing 100 also includes a back panel 230 unitary with the sidewalls.

Enclosure 150 also includes a unitary pair of spaced-apart elastically deformable sidearms 152, 154 (FIG. 6) designed, adapted, and configured for snap engaging the enclosure 150 to the housing 100 through an aperture (not shown) though sidewall 226.

In embodiments, a front panel (not shown) adapted and configured to be spaced from back panel 230 is used to keep dirt and/or moisture away from the enclosure 150. Such front panel may include elastically deformable tabs or other structural features for enabling such front panel to be snap engageable with the housing 100. Or the front panel may be releasably securable to the housing 100 by threaded fasteners (also not shown). Known housings using threaded fasteners to secure front panels are disclosed, for example, in U.S. Pat. No. 3,253,730 to Mount hereby incorporated by reference in its entirety.

FIG. 7 depicts a schematic in which a switch, when closed, causes the electrical circuit, disposed in enclosure 150 (FIGS. 5, 6), to be subjected to a 24-volt AC load and the electrical continuity indicator 70 (which may be an LED indicator) to be illuminated. The enclosure 150 also includes a toggle or rocker switch 250 (FIGS. 6, 7) which may be used to close the 24-volt electrical circuit (FIG. 7), when using the apparatus or tool 50 of the present subject matter to test furnace system switches, as described in detail above.

Described in this patent specification is a furnace diagnostic by-pass tool. While the present subject matter is described with reference to an exemplary embodiment, the present subject matter is not limited to the exemplary embodiment. On the contrary, alternatives, changes, and/or modifications shall become apparent to a person of ordinary skill in the art (“POSITA”) after this specification is read and its figures reviewed. Thus, all alternatives, changes, and modifications are to be treated as forming a part of the present subject matter insofar as they fall within the spirit and the scope of the appended claims.

1. A diagnostic by-pass apparatus (50) electrically connectable to a pressure switch, a roll-out switch, and a limit switch of a furnace, wherein each switch has two terminals,
wherein the apparatus (50) comprises:
a housing (100);
an enclosure (150) disposed in the housing (100);
an electrical circuit disposed in the enclosure (150);
a first lead electrical connection that is electrically connected to the circuit and that is electrically connectable either to one of the two terminals of the pressure switch, or to one of the two terminals of the roll-out switch, or to one of the two terminals the limit switch;
a second lead electrical connection connected to the circuit and connectable:
to the other one of the two terminals of the pressure switch of the furnace, or
to the other one of the two terminals of the roll-out switch of the furnace, or
to the other one of the two terminals of the limit switch of the furnace, wherein the pressure switch of the furnace, the roll-out switch of the furnace, the limit switch of the furnace, and combinations thereof are defective; and
an electrical continuity indicator (70) operatively connected to the circuit, wherein the indicator is adapted and configured to identify the defective pressure switch, the defective roll-out switch, and/or the defective limit switch of the furnace.

2. The diagnostic by-pass apparatus (50) of claim 1, wherein the electrical continuity indicator (70) is an LED indicator (70).
